(19) United States
(12) Patent Application Publication
(10) Pub. No.: US 2015/0028976 A1
(43) Pub. Date: Jan. 29, 2015

(54) Rare-Earth Magnet

(71) Applicant: Hiroshi Moriya, Tokyo (JP)

(72) Inventor: Hiroshi Moriya, Tokyo (JP)

(73) Assignee: Hitachi, Ltd., Tokyo (JP)

(21) Appl. No.: 14/379,707

(22) PCT Filed: Mar. 26, 2012
(86) PCT No.: PCT/JP2012/057805

§ 371 Date: Aug. 19, 2014

(51) Int. Cl. H01F 7/02; H01F 1/40; H01F 1/42

(52) U.S. Cl. CPC H01F 7/02; H01F 1/42; H01F 1/40
USPC 335/302

(57) ABSTRACT

The purpose of the present invention is to provide a structure of a rare-earth magnet having high coercivity. In order to solve the problem, a rare-earth magnet according to the present invention comprises sheets of elements bonded with each other through a covalent bond 100 and layers comprising a transition metal element 200 laminated with the sheet 100, wherein a rare earth element is arranged within a plane of the sheets.

### TECHNICAL FIELD

The present invention relates to a rare-earth magnet.

### BACKGROUND ART

An Nd—Fe—B sintered magnet was invented in 1982, has been served as a permanent magnet material having the highest performance in the world up until now and employed in a number of products including voice coil motors (VCMs) for hard disc drives (HDDs), nuclear magnetic resonance imaging (MRI) apparatuses, and power generators. The production of the Nd—Fe—B sintered magnet has been on an upward trend particularly in applications for motors and power generators because of measures for energy-saving. Moreover, the Nd—Fe—B sintered magnet is the most promising magnetic material for large-sized driving motors in Hybrid Electric Vehicles (HEVs) which have been developed with consideration for environmental pollution, and therefore, further expanding production has been expected.

A Maximum energy product and a coercivity are indexes indicating magnetic material performance. The maximum energy product refers to a maximal energy which a magnet can generate. The coercivity refers to a magnetic field which, when a reverse magnetic field is applied to a magnetized magnet, cancels the magnetization.

The Nd—Fe—B magnet has been improved since its invention in 1982, whereby it currently possesses a maximum energy product approximately twice as larger as that of an Sm—Co magnet which had had the highest performance until then. On the other hand, the Nd—Fe—B magnet possesses a coercivity that is only around a half of that of the Sm—Co magnet.

In general, it is required to possess a large saturation magnetization and a large coercivity in order to enhance the maximum energy product as a performance index for permanent magnets. As a basic technology for improving the Nd—Fe—B sintered magnet so as to possess an enhanced coercivity, a method in which Nd is partially replaced with Dy, a heavy rare earth, to enhance magnetocrystalline anisotropy has been currently known. Patent Literature 1, for example, discloses a permanent magnet which is prepared by wet-mixing a Dy compound and a magnet raw material to coat the raw material surface with the Dy compound, mixing the coated raw material with a resin binder and forming a green sheet, and sintering the green sheet. Also Patent Literature 2 discloses a rare earth sintered magnet comprising a plurality of crystal grains of R₂T₁₄B (R is a rare earth element such as Nd or Dy, and T is a transition metal element such as Fe) and crystal grain boundaries which exist between the neighboring crystal grains and have larger amounts of Nd and Cu and a smaller amount of Dy than the surface of the crystal grains.

Magnetic moment of Dy, however, has a nature to be combined with those of Nd and Fe in antiparallel. Therefore, there exists a problem that although coercivity of the Nd—Fe—B sintered magnet increases by addition of Dy, magnetization decreases and consequently the maximum energy product decreases as the amount of Dy added increases. In the products having low operating temperatures upon use of the magnets, such as MRI or speakers, since a high coercivity is not required at an elevated temperature, almost no Dy is added to the magnet and the Nd—Fe—B magnet having a maximum energy product up to about 50 MGOe is also employed. On the other hand, in the motors employed in HEVs, the Nd—Fe—B magnet having a coercivity as high as 30 kOe at room temperature is required in consideration of the temperature dependence of the coercivity since the operating temperature is 200° C. or higher. In this case, it is necessary to add about 10% of Dy and this results in a reduction in maximum energy product down to about 30 MGOe. That is, addition of Dy to the Nd—Fe—B magnet enhances the coercivity, while sacrificing the large maximum energy product which is a characteristic of the Nd—Fe—B magnet.

In addition, since a Dy content in a rare earth ore is low and its places of origin is unevenly distributed in China, there is a concern that when the Nd—Fe—B magnets are supplied in a large amount for HEV uses, Dy market price may jump up and actually result in impossibility of HEV production in near future. Based on such a background, it is currently highly required to develop a high-performance permanent magnet having both a high maximum energy product and a high heat durability in a manner to obtain a high coercivity, while adding no or reduced Dy in amount.

### CITATION LIST

### Patent Literature

Patent Literature 1: JP Patent Publication (Kokai) No. 2009-224671A (2009)

Patent Literature 2: JP Patent Publication (Kokai) No. 2011-187734A (2011)

### SUMMARY OF INVENTION

### Technical Problem

Accordingly, the present invention is intended to provide a rare-earth magnet structure exhibiting a high coercivity.

### Solution to Problem

In order to solve the problem described above, the present inventor has intensively researched and consequently found that a high coercivity can be obtained by arranging a rare earth element within a two-dimensional plane of a sheet having strong covalent bonds and laminating the sheet with a layer comprising a transition metal element to complete the present invention.

That is, a rare-earth magnet according to the present invention comprises a sheet of an element bonded with each other through a covalent bond and a layer comprising a transition metal element laminated with the sheet, wherein a rare earth element is arranged within a plane of the sheet.

### Advantageous Effects of Invention

According to the present invention, since a rare earth element is arranged within a sheet having strong covalent bonds, crystal structures are difficult to be disturbed in the vicinity of the grain boundary faces and the magnetic anisotropy is high in the vicinity of the grain boundary faces, and a rare-earth magnet having a high coercivity can be obtained. Technical problems, configurations and effects other than those described above will be shown by the illustration of the embodiments below.

### BRIEF DESCRIPTION OF DRAWINGS

FIG. 1 is a schematic diagram showing a cross section structure of one embodiment of a rare-earth magnet according to the present invention.

FIG. 2 is a drawing showing one embodiment of a sheet structure in the rare-earth magnet according to the present invention.

FIG. 3 is a drawing showing Nd₂Fe₁₄B crystal structure used for determining a crystal field parameters.

FIG. 4 is a drawing showing results of the analyses for the crystal field parameters

FIG. 5 is a drawing illustrating that the crystal field parameters vary depending on surface models.

FIG. 6 is a drawing illustrating that the crystal field parameters vary depending on the surface models.

FIG. 7 is a drawing illustrating a mechanism for the coercivity decrease in the rare-earth magnet.

### DESCRIPTION OF EMBODIMENT

The present invention will be illustrated in detail below referring to the drawings.

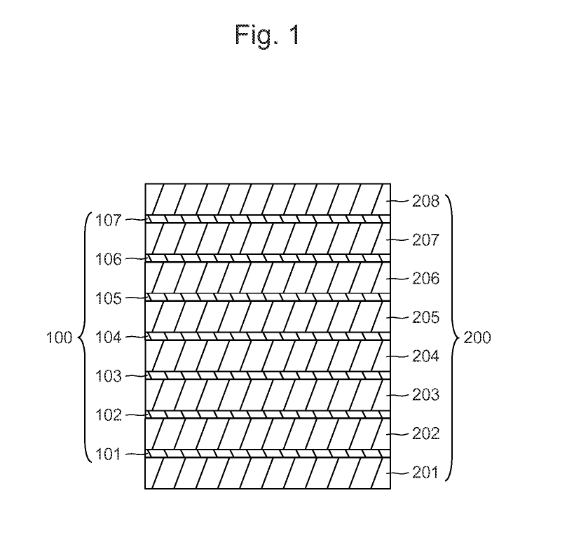

FIG. 1 shows a cross section structure of the main part of one embodiment of the rare-earth magnet according to the present invention. In FIG. 1, sheets of an element bonded with each other through a covalent bond 101, 102, 103, 104, 105, 106 and 107 (hereinafter, referred to as sheets 100) and layers consisting of transition metal element 201, 202, 203, 204, 205, 206, 207 and 208 (hereinafter, referred to as layers consisting of transition metal element 200) form a laminated structure. In the rare earth magnet having such a laminated structure, the easy axis of magnetization (c axis) is directed to the direction of lamination of the sheets 100 and the layers consisting of transition metal element 200.

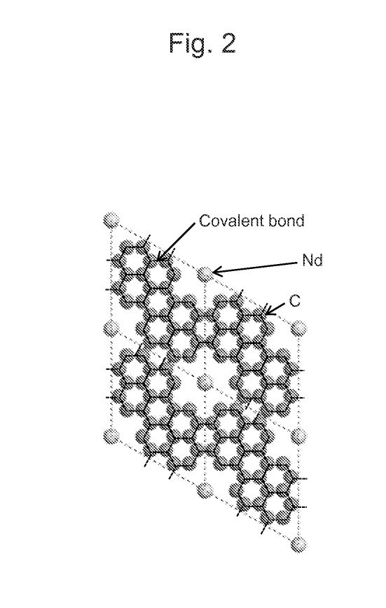

The element constituting the sheets 100 are at least one selected from the group consisting of, for example, C, Si and Ge. The rare earth element is, for example, at least one selected from the group consisting of Nd, Tb and Dy. Furthermore the element constituting the layers consisting of transition metal element 200 is, for example, at least one selected from the group consisting of Ti, V, Cr, Mn, Fe, Co, Ni and Cu. FIG. 2 shows an exemplary arrangement of atoms within a plane of the sheets 100, where carbon atoms are bonded tightly with each other through a covalent bond similarly to a graphene structure and neodymium Nd is arranged as the rare earth element within the plane thereof. Since the rare earth element is arranged within the plane of the sheet of the element formed through strong covalent bonds in this manner, the crystal structures are difficult to be disturbed in the vicinity of the grain boundary faces, and the rare-earth magnet having the high coercivity can be obtained. The mechanism for this will be illustrated in detail below.

An anisotropic magnetic energy is an index which determines a magnitude of the coercivity. When a magnetization is rotated in an angle α to the easy axis of magnetization, magnetocrystalline anisotropic energy E_{A} is represented by the following expression:

E_{A}=K₁ sin² α+K₂ sin⁴ α+K₃ sin⁶ α+ . . . [Expression 1]

where, K₁, K₂ and K₃ are magnetocrystalline anisotropy constants which are the indexes indicating magnitudes of the anisotropy.

In a simplified case, using the first term only, E_{A} is represented by the following expression:

E_{A}=K₁ sin² α [Expression 2]

This magnetocrystalline anisotropy constant K₁ is calculated by the following expression:

K₁=−3J(J−½)α_{J} [symbol] r² [symbol] A₂⁰ [Expression 3]

where, J represents a total angular momentum of a rare earth ion and <r²> represents an expected value for r² concerning a radial wave function of the 4f electrons (expected squared value for the position coordinate of the 4f electrons). α_{J} is a parameter depending upon the spatial distribution geometry of the 4f electrons, which is referred to as Stevens factor. These J, <r²> and α_{J} take fixed values depending upon the type of the rare earth ion, respectively, and in the case of an Nd ion, for example, J=9/2, α_{J}=−7/(3²×11²), and <r²>=1.001a₀ (where, a₀ is the Bohr radius 0.5291772108×10⁻¹⁰ m). In addition, A₂⁰ is a principal term of the crystal field parameters and the correlation between K₁ and A₂⁰ for Nd ion is represented by K₁=0.347A₂⁰<r²> when the values are substituted for J and α_{J} in the above expression. That is, the conditions for obtaining large anisotropy are that A₂⁰ takes a positive value and A₂⁰ takes a large value. It is noted that the crystal field parameters are amounts depending upon the electronic states. That is, if a crystal structure of a rare-earth magnet having a large anisotropic magnetic energy could be found through determining the crystal field parameters by the electronic state calculation using, for example, the first-principles calculation, then it would be possible to obtain a rare-earth magnet having a large coercivity.

Accordingly, a calculation example of the crystal field parameters for an Nd₂Fe₁₄B magnet, as a conventional structure, by the electronic state calculation using the first-principles calculation will be shown, and subsequently, based on the results, a guideline for enhancing the anisotropic magnetic energy of the rare-earth magnet and increasing the coercivity thereof will be presented.

The electronic state calculation for Nd₂Fe₁₄B was analyzed by the Full-potential Linearized Augmented Plane Wave (FLAPW) method based on the Density Functional Theory (DFT). In an ordinary electronic state calculation, it is usual to assume spherical symmetry for electron density or one-electron potential within a sphere around each atom (Muffin-tin sphere). It is, however, necessary to calculate the state of the localized 4f electrons in an Nd ion accurately for derivation of the crystal field parameters relating to the magnetic anisotropy of the Nd ion. It is not appropriate to assume spherical symmetry for the electron density or the one-electron potential in order to determine the electron state accurately in the solid. Accordingly, the present inventor performed the first-principles calculation using Full-potential. Full-potential refers to a method taking aspherical surface effects into consideration for the one-electron potential, charge, and spherical harmonics of the core electrons. In addition the Linearized Augmented Plane Wave (LAPW) method linearizes the radial wave function concerning energy and employs the augmented plane wave as the basis function, thereby being able to reduce the calculation load without deterioration of calculating accuracy for both within and outside of the Muffin-tin spheres. In the pseudopotential method which is most commonly used in the first-principles calculation, only valence electrons are treated in the calculation while calculating the core electrons by means of substitution as the pseudopotential. On the other hand the FLAPW method treats all the electrons, and therefore, it can be one of the methods having the highest accuracy among the current first-principles calculation techniques. In the present embodiment, the FLAPW method was employed in the electronic state calculation for Nd₂Fe₁₄B. The first-principles calculation program used was WIEN2k, which is a general purpose code developed by Professor K. Schwartz (Vienna University of Technology) et al.

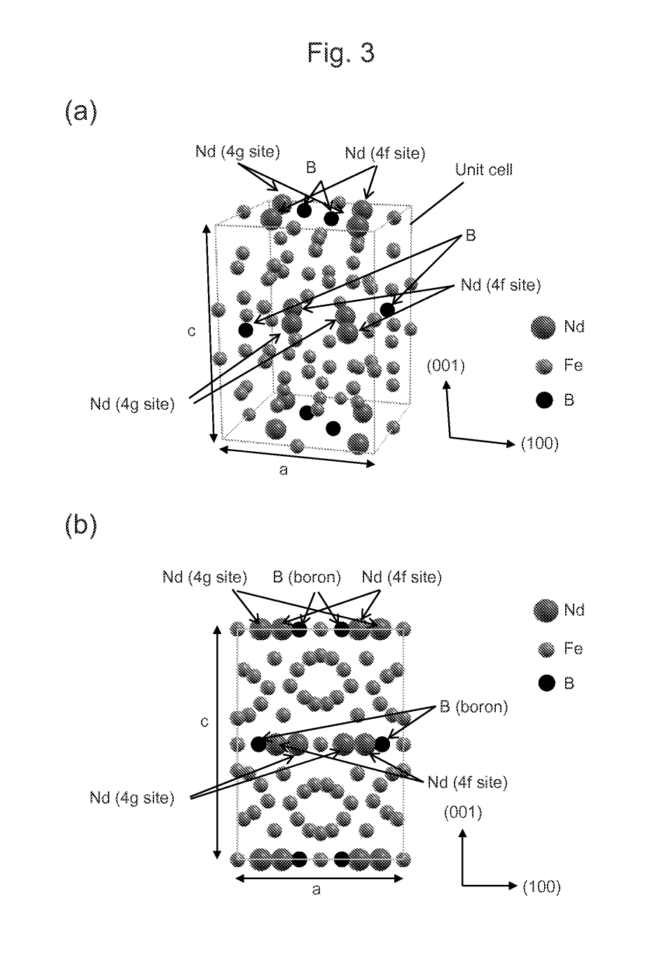

In FIGS. 3(a) and 3(b), the atomic arrangement of Nd₂Fe₁₄B which is the model for the electronic state calculation is shown. The lattice constants at room temperature are a=8.8 Å and c=12.2 Å. One unit cell contains 68 atoms in total and the crystal structure can be represented with 9 sites in total, i.e., 2 sites (f, g) for Nd, 6 sites (k₁, k₂, j₁, j₂, c, e) for Fe, and 1 site (g) for B, due to the symmetry. The Muffin-tin radiuses for Nd, Fe and B atoms were given as R_{MT}=2.80a₀, 2.08a₀, 1.85a₀ (a₀=0.052918 nm), respectively. Calculation was first performed with a sample number of k points set to 3 in the Irreducible Brillouin zone and separate calculations were performed with differently set sample numbers of k point to confirm convergence of the crystal field parameters. R_{MT}Kₘₐₓ which is an amount to determine the cut-off energy of the plane wave was set to 7. Also with respect to R_{MT}Kₘₐₓ, separate calculations were performed with differently set values to confirm convergence of the crystal field parameters. For exchange-correlation energy between the electrons, Generalized Gradient Approximation (GGA) taking the local density slope in consideration was employed. The 4f electrons in the rare earth atoms such as Nd treated in the present embodiment are strongly localized. For taking this locality into consideration, analyses taking compensation for the Coulomb interaction between the localized electrons (U) into consideration (LDA+U method) were performed. With respect to the value for the compensation U for the 4f electrons in Nd, U=6 eV was employed as the U value with which the analytical results of the optical properties of NdO crystal such as a reflectance consisted with the experimental results.

Then, the method for analyzing the crystal field parameters will be illustrated. The crystal field parameters are obtained using the following expression:

A₂⁰ [symbol] r² [symbol] =4πa₂₀∫₀^{∞}drr²V₂⁰(r)ρ_{4f}(r) [Expression 4]

wherein, V₂⁰(r) is a one-electron potential energy component, which is a component when V_{cry}, a crystal electric field potential acting on the rare earth ion, is expanded using the following real spherical harmonics:

Z_{L}^{M}(\hat{r}) [Expression 5]

as shown in the following expression:

$${V}_{cry} ( r ) = {\sum }_{L , M} {V}_{L}^{M} ( r ) {Z}_{L}^{M} ( \hat{r} ) . \qquad [ Expression 6 ]$$

In addition, ρ_{4f}(r) is a density of the 4f electrons. a₂₀ is a numerical factor of Z₂⁰ and satisfies the following expression:

a₂₀=\sqrt{5/4π}/2 [Expression 7]

Further, <r¹> is an average of the squared radial coordinate r² for the 4f electrons, which is obtained by the following expression:

[symbol]

r¹ [symbol] =4π∫drr²r¹ρ_{4f}(r). [Expression 8]

The results of the calculation and literature data of the experimental results for the crystal field parameter, A₂⁰<r²>, are shown in Table 1. According to the literature (Motohiko Yamada, Hiroaki Kato, Hisao Yamamoto, and Yasuaki Nakagawa: Crystal-field analysis of the magnetization process in a series of Nd₂Fe₁₄B-type compounds, Phys. Rev. B 38, 620 (1988)), the crystal field parameter, A₂⁰<r²>, which reproduces the magnetization curve determined by the experiment, is estimated to be about 300K, translating into the result close to those obtained in the calculation in the present embodiment. Particularly, A₂⁰<r²> values are positive for both the Nd (f) site and Nd (g) site. In order that Nd₂Fe₁₄B bulk has uniaxial anisotropy and the c axis becomes the easy axis of magnetization, A₂⁰<r²> values are required to be positive. The calculation results for the crystal field parameters of the present embodiment satisfied the conditions, whereby suitability of the calculation method was confirmed.

TABLE 1

| | | Calculation result | Literature data |
|---|---|---|---|
| A₂⁰<r²> | Nd(4f) | 427 | ~300 |
| [K] | Nd(4g) | 464 | |

Then, factors affecting the magnitude of the crystal field parameters will be investigated.

Low coercivity regions are considered to exist in the vicinity of the grain boundary faces in the Nd—Fe—B magnet, and it is therefore thought to be effective to clarify the correlation between the crystal structures and the magnetic properties in the vicinity of the Nd₂Fe₁₄B grain boundary faces of from an electron theory in order to obtain a guiding principle for enhancing the coercivity performance. The structures at the crystal grain boundaries in the Nd—Fe—B magnet are complicated, however, and it is difficult to treat the actual system in a manner of first-principles.

Accordingly, in the present embodiment, crystal field parameters in a Nd₂Fe₁₄B surface model are analyzed to evaluate the presence of a difference from the Nd₂Fe₁₄B bulk model, whereby the correlation between the crystal structures and the magnetic properties in the vicinity of the grain boundary faces will be studied. It is noted that there exists arbitrariness in respect of surface orientation and surface formation upon creating a surface model. Thus, in the present embodiment, effects of the surface formation on the Nd ion crystal field parameters were investigated employing five cases, i.e., Nd ion-exposed and unexposed Nd₂Fe₁₄B (001) surface models, Nd ion-exposed and unexposed Nd₂Fe₁₄B (100) surface models, and Nd ion-exposed Nd₂Fe₁₄B (110) surface model, as the objects to be analyzed, the results obtained were summarized, and then a study was carried out concerning how the surface formation affects the magnetocrystalline anisotropy.

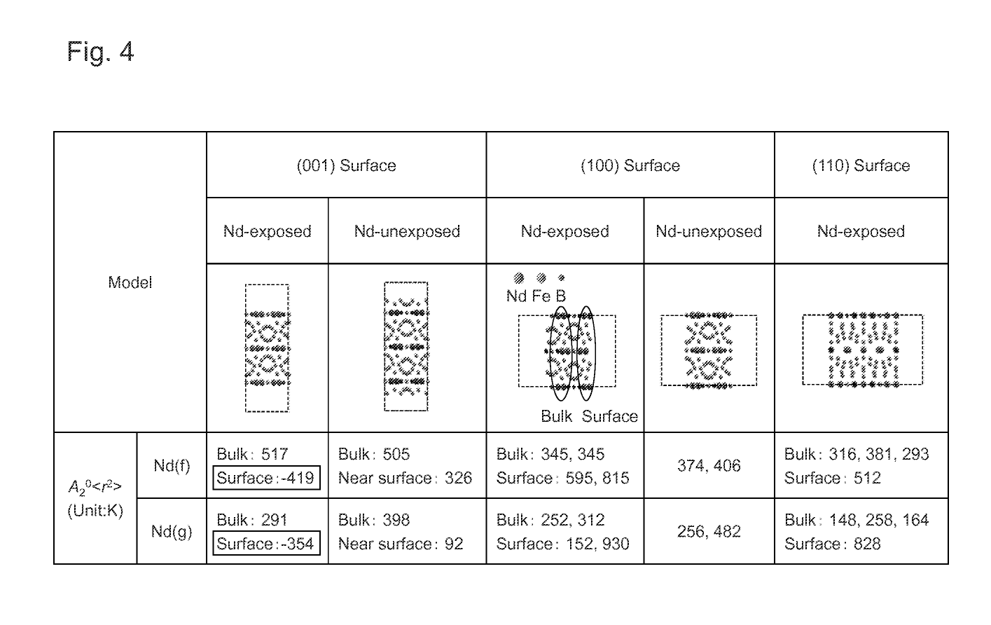

The calculation results of the crystal field parameter, A₂⁰<r²>, are summarized for the various analyzed surface models in FIG. 4. Analyses were performed for the (001) surface, (100) surface, and (110) surface but, as clearly shown in FIG. 4, the crystal field parameter, A₂⁰<r²>, of the Nd ion exposed on the surface has a negative sign for the (001) surface model only and the parameter remained to have a positive sign for other exposed models. That is, these results show that the values of crystal field parameter, A₂⁰<r²>, have different signs depending upon the surface orientation even when the Nd ion is exposed.

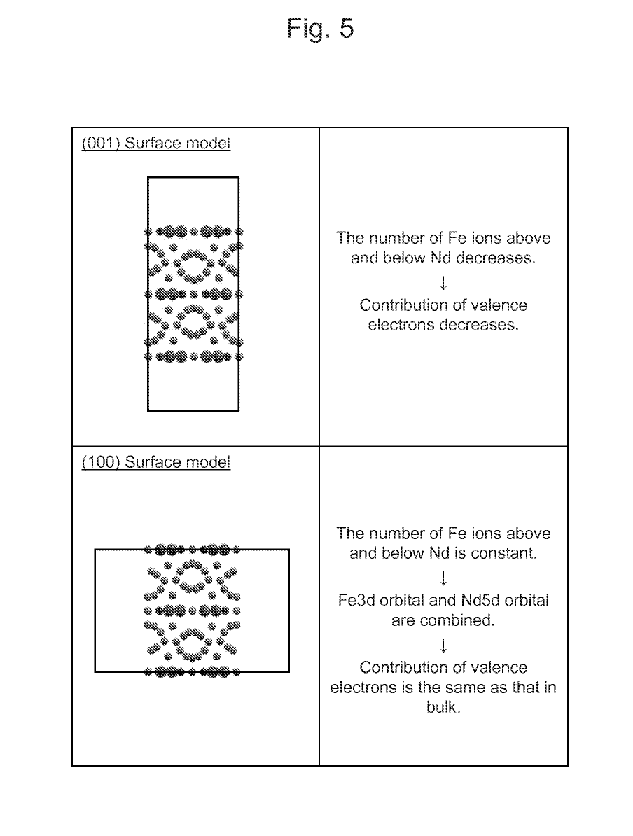

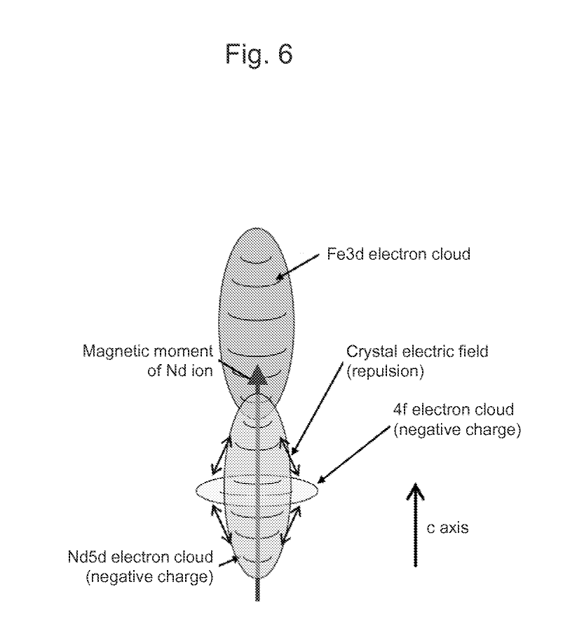

The difference between the Nd ion-exposed (001) surface model where the crystal field parameter, A₂⁰<r²>, has a negative value and other models where the A₂⁰<r²> has a positive value is the existence of the Fe ions along the direction of the c axis (easy axis of magnetization, z axis) of the Nd ion of interest (FIG. 5). Namely, it is considered that a mechanism for changing the signs of the crystal field parameters of the Nd ion depending upon the surface orientation may be attributable to a shape change of the valence-electron cloud in the Nd ion itself due to decreased number of the Fe ions above and below the Nd ion by the formation of the surface. The crystal field parameters are determined by the contribution of the electric field from the valence electrons other than the 4f electrons (hereinafter, simply referred to as valence electrons) in the rare earth ion and the contribution of the electric field from the surrounding ions. In this situation, a change of the electric field from the valence electrons by forming a surface is considered. In the bulk model Fe ions exist above and below (c axis direction) the Nd ion. Also in the (100) surface model, since the surface is formed vertically to the lamination direction of the Fe sublattice layer and the layer containing the Nd ion, Fe ions exist above and below (c axis direction) the Nd ion. Therefore the 3d electron cloud of the Fe ion and the 5d electron cloud of the Nd ion are thought to form a combination extended along the c axis direction as shown in FIG. 6 (precisely, the Fe closest to the Nd is located in a position shifted from the c axis by 20 degrees as seen from the Nd ion). This combination results in the 5d electron cloud of the Nd ion directed in the c axis direction. Since a repulsion acts between the 5d electron cloud of the Nd ion and the 4f electron cloud, the doughnut shape axis of the 4f electron cloud tends to be directed in the c axis direction. It may be considered that this makes also the magnetic moment of the Nd ion directed in the c axis direction, the contribution of the valence electrons on the crystal field parameters works in the similar degree as in the bulk, and therefore the A₂⁰<r²> has a positive sign. On the other hand, in the Nd-exposed (001) surface model no Fe ions exist in the surface side and this decreases the repulsion directing the 5d electron cloud of the Nd ion to the c axis direction. This is thought to result in the reduced crystal electric field from the valence electrons.

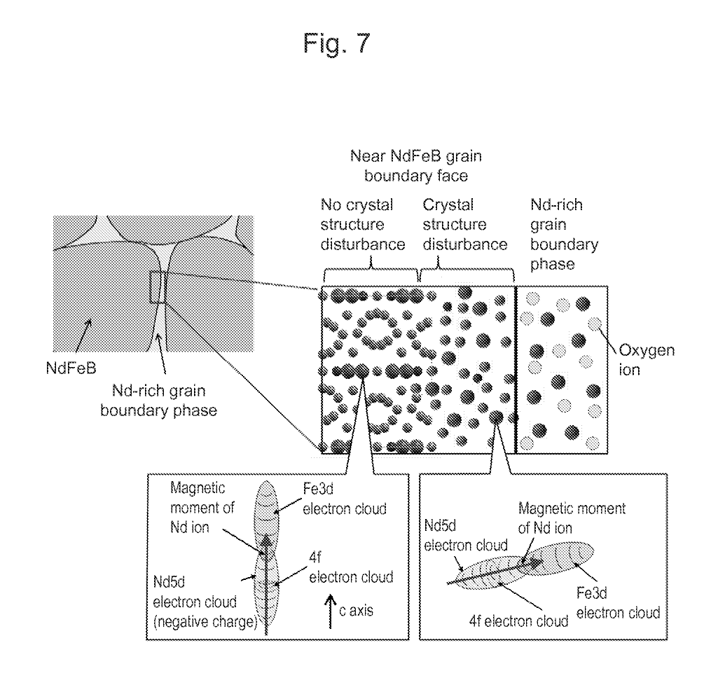

Based on the results described above, the guideline for enhancing the coercivity of the rare-earth magnet will be investigated. Low coercivity regions are considered to exist in the vicinity of the grain boundary faces in the Nd—Fe—B magnet. In FIG. 7 at the upper left there is shown a schematic diagram of the Nd₂Fe₁₄B crystal grains and the Nd-rich grain boundary phases in the Nd—Fe—B magnet. The drawing at the upper right in FIG. 7 is a diagram enlarging the grain boundary face and schematically showing the atomic arrangement and the diagram indicates the case in which the crystal structure is disturbed in the vicinity of the grain boundary of Nd₂Fe₁₄B. In the region where the Nd₂Fe₁₄B crystal structure is not disturbed, the Nd ion layer has a structure sandwiched by the Fe ion layers and the Fe ions are located above and below the Nd ions. Since the 5d orbital of the Nd ion and the 3d orbital of the Fe ion are combined with each other, both the 5d electron cloud and the 3d electron cloud are directed in the c axis direction, the 4f electron cloud receives the Coulomb repulsion from the valence-electron cloud to have a shape spread in an in-plane direction, and then the magnetic moment of the Nd ion is directed in the c axis direction. On the other hand, in the region where the Nd₂Fe₁₄B crystal structure is disturbed the arrangement of the Nd ions and the Fe ions has no regularity, and therefore, the correlation of the 5d electron cloud and the 3d electron cloud in their arrangement is thought to be almost random even if the 5d orbital of the Nd ion and the 3d orbital of the Fe ion are combined with each other. Accordingly the 4f electron cloud also would not have a shape spread in an in-plane direction and the magnetic moment of the Nd ions would be directed in a direction other than that of the c axis or in-xy plane direction. Consequently the magnetic anisotropic constant of the Nd ions within the disturbed crystal structure is thought to have easily a negative value. This negative anisotropic constant in the vicinity of the boundary face is thought to reduce the coercivity. That is, it is considered that when there exists the crystal structure disturbance in the vicinity of the grain boundaries, the crystal field parameters of the Nd ions have negative values, thereby reducing the coercivity.

Based on the mechanism described above, the present inventor has attained an idea described below. That is, in order to enhance the coercivity of the rare-earth magnet, it is desirable to strengthen the two-dimensional structure of the layers containing the rare earth element so as to give a structure in which there exists less disturbance of the two-dimensional structure even in the vicinity of the grain boundaries and the transition metal element is located above and below the rare earth ions in the c axis direction. The element constituting the two-dimensional structure may be bonded through covalent bonds in order to strengthen the two-dimensional structure.

Whether an element constituting the two-dimensional structure forms a covalent bond or not is determined by the most closely neighboring interatomic distance for atoms thereof. When C, Si and Ge have a diamond structure, the most closely neighboring interatomic distances are 0.154 nm, 0.235 nm and 0.245 nm, respectively. Therefore when C, Si and Ge have a two-dimensional structure, they are thought to form covalent bonds in the case of having interatomic distances of approximately above-described distances ±10%. That is, when the element is C and the most closely neighboring distance is 0.13 nm or more and 0.16 nm or less, the element will form covalent bond, when the element is Si and the most closely neighboring distance is 0.21 nm or more and 0.26 nm or less, the element will form covalent bond, and when the element is Ge and the most closely neighboring distance is 0.22 nm or more and 0.27 nm or less, the element will form covalent bond.

Then a method for manufacturing the rare-earth magnet shown in FIG. 1 will be illustrated. Here, as an example, a case in which the transition metal element is Fe, the rare earth element is Nd, and the element of the sheet bonded through covalent bonds is C will be illustrated. At first, a film of Fe, as the transition metal, is formed with a thickness of, e.g., about 0.5 nm, on a substrate composed of Si or the like using the sputtering method. Subsequently one layer of 3C—SiC film is formed using the Molecular Beam Epitaxy (MBE) method. Si is, then, removed by vacuum annealing at 1200° C. to form graphene containing defects. It is noted that the transition metal crystal which is the base material for the 3C—SiC film and graphene have lattice mismatching, thereby containing the defects. A rare earth film is then formed using the vacuum deposition method or the like. The Nd film is then removed using the Ar sputtering method but Nd located in the defects in the graphene is not removed to remain due to metallic bonding with Fe as the base material. This can lead to a two-dimensional sheet of carbon C bonded through covalent bonds containing rare earth element within the plane of the sheet. Subsequently, the same steps as those described above, such as forming a film of Fe, as the transition metal, with a thickness of, e.g., about 0.5 nm using the sputtering method and the like, are carried out in succession to form a rare-earth magnet in which a sheets of element C bonded through covalent bonds containing rare earth element Nd located within the two-dimensional plane of the sheet and layers consisting of a transition metal element are laminated with each other alternately.

As the substrate on which the film of the transition metal or 3C—SiC, a material which is nonmagnetic and excellent in flat smoothness is preferred. Surface roughness of the substrate is defined by JIS B0601 or ISO468. Desirably a arithmetic mean roughness Ra is 1.0 μm or less, preferably 0.5 μm or less, and more preferably 0.1 μm or less. With regard to flatness of the substrate, the more flat, the more desirable. Commercially a monocrystal Si wafer for semiconductor device manufacturing is preferably employed as the substrate because of extremely excellent surface roughness and flatness thereof. In addition to the monocrystal Si wafer, a polycrystal Si wafer, a cleavage plane of RB₂C₂ (R is a rare earth element) in which a rare earth element is arranged within the same plane in the crystal, or the like is also applicable.

The coercivity can be further enhanced by heat-treating the laminate after film formation in vacuo or an inert gas atmosphere as necessary so as to remove point defects and lattice strain which may be generated at, for example, a junction of the sheet and the layer comprising a transition metal element. The temperature of the heat-treating varies depending upon the composition or film thickness, but is preferably 600 K-900 K. When the heat-treating is performed at a lower temperature for a longer time, mutual diffusion of the rare earth element and the transition metal element can be inhibited, and therefore, the material having higher magnetic properties can be easily obtained as a result.

Furthermore the rare-earth magnet of the present invention may be surface-treated to form a protective film for preventing oxidation in the atmosphere as necessary. As the protective film resin films can be applied in addition to metallic films excellent in corrosion resistance and strength and polyimide film or the like may be employed. As the surface-treating method Al coating using the vapor phase growth method or Ni plating using a known plating method is preferred and a relatively thinner thickness of the protective film is desirable not to decrease the volume magnetic properties. It may be suitably selected whether to surface treat before processing into the final product or to surface treat after the processing depending upon product forms or uses.

It should be noted that the present invention is not limited to the embodiment described above but may include various modifications. It is possible, for example, to replace a part of a constitution of a certain embodiment with a constitution of other embodiment, or alternatively, it is possible to add a constitution of other embodiment to a constitution of a certain embodiment. Also, with respect to a part of a constitution of each embodiment it is possible to add other constitution thereto, eliminate it, or substitute it.

All the publications, Patents and Patent applications cited herein are incorporated herein in their entirety by reference.

### REFERENCE SIGNS LIST

100-107: Sheets
200-208: layers consisting of a transition metal element

1. A rare-earth magnet comprising a sheet of an element bonded with each other through a covalent bond and a layer comprising a transition metal element laminated with the sheet, wherein a rare earth element is arranged within a plane of the sheet.

2. The rare-earth magnet according to claim 1, wherein the rare earth element is at least one selected from the group consisting of Nd, Tb and Dy.

3. The rare-earth magnet according to claim 1, wherein the transition metal element is at least one selected from the group consisting of Ti, V, Cr, Mn, Fe, Co, Ni and Cu.

4. The rare-earth magnet according to claim 1, wherein the element bonded with each other through a covalent bond is at least one selected from the group consisting of C, Si and Ge.

5. The rare-earth magnet according to claim 4, wherein the element bonded with each other through a covalent bond is C and the most closely neighboring distance between these elements is 0.13 nm or more and 0.16 nm or less.

6. The rare-earth magnet according to claim 4 wherein the element bonded with each other through a covalent bond is Si and the most closely neighboring distance between these elements is 0.21 nm or more and 0.26 nm or less.

7. The rare-earth magnet according to claim 4 wherein the element bonded with each other through a covalent bond is Ge and the most closely neighboring distance between these elements is 0.22 nm or more and 0.27 nm or less.
